(19) United States
(12) Patent Application Publication
(10) Pub. No.: US 2025/0051489 A1
(43) Pub. Date: Feb. 13, 2025

(54) PROCESS OF MANUFACTURING GRAFT POLYMER COMPOSITIONS

(71) Applicant: SABIC GLOBAL TECHNOLOGIES B.V., Bergen op Zoom (NL)

(72) Inventors: Dejin Li, Newburgh, IN (US); Nasser Mansour Alsubaie, Riyadh (SA)

(21) Appl. No.: 18/723,717

(22) PCT Filed: Dec. 16, 2022
(86) PCT No.: PCT/EP2022/086305

§ 371 Date: Jun. 24, 2024

(30) Foreign Application Priority Data
Dec. 27, 2021 (EP) 21217794.3

(51) Int. Cl. C08F 2/22; C08F 4/34; C08F 4/40; C08F 212/08; C08F 220/14; C08F 220/44; C08F 279/02

(52) U.S. Cl. CPC C08F 2/22; C08F 4/34; C08F 4/40; C08F 212/08; C08F 220/14; C08F 220/44; C08F 279/02

(57) ABSTRACT

An emulsion polymerization process of manufacturing a graft polymer composition with a reduced residual monomer content includes feeding a vinyl aromatic monomer, an unsaturated nitrile, and a first portion of an initiator to a reactor having a temperature of 50 to 63° C., the reactor containing an initial reaction system comprising water and a diene emulsion. After 10% to 35% of the first portion of the initiator has been added, the reactor temperature is increased to 65 to 85° C. The polymerization reaction runs for 0 to 30 minutes, then a second portion of the initiator and a third monomer are added, and the reaction is allowed to proceed for a second non-charging reaction time to produce the graft polymer composition. In the process, the vinyl aromatic monomer and the unsaturated nitrile are fed to the reactor in 10 to 40 minutes. The process time can be less than 145 minutes.

### BACKGROUND

This disclosure relates to process of manufacturing graft polymer compositions, and in particular to process of manufacturing graft polymer compositions with low residual monomers.

Graft polymers such as acrylonitrile-butadiene-styrene (ABS) can be used to impart impact resistance and toughness in many applications. ABS polymers are generally made by polymerizing acrylonitrile and styrene in the presence of polybutadiene. For certain applications it is important that the residual monomer content in the polymers be low to avoid volatile organic compounds (VOC) in the final products.

The normal approaches to improve monomer conversion include increasing the reaction temperature and extending the reaction time. In certain instances, additional monomers can be used to aid in the conversion of styrene and acrylonitrile. However, with existing approaches, the residual monomer levels can still be higher than desirable. In addition, some approaches are energy, time, or material consuming and can potentially introduce problems such as black specks in the products due to the increased reaction temperature or extended reaction time. Accordingly, continuous efforts are ongoing to increase the conversion of the monomers used in the polymerization reaction, which can then result in less residuals in the final products.

### SUMMARY

An emulsion polymerization process of manufacturing a graft polymer composition with a reduced residual monomer content is disclosed. The process comprises:
feeding a vinyl aromatic monomer, an unsaturated nitrile, and a first portion of an initiator to a reactor having a temperature of 50 to 63° C., preferably 52 to 63° C., more preferably 55 to 60° C., during a first charging period, the reactor containing an initial reaction system comprising water and a diene emulsion;
after 10% to 35%, 30 to 35%, or 10 to 20% of the first portion of the initiator has been added to the reactor, increasing the reactor temperature to a second temperature of 65 to 85° C., or 70 to 80° C. during the first charging period;
allowing a polymerization reaction in the reactor to proceed for a first non-charging reaction time of 0 to 30 minutes at the second temperature after the first charging period ends and before a second charging period starts;
feeding a second portion of the initiator and a third monomer to the reactor having the second temperature during the second charging period, wherein the third monomer is at least one of a methyl acrylate, ethyl acrylate, butyl acrylate, 2-ethylhexyl acrylate, cyclohexyl acrylate, benzyl acrylate, isopropyl acrylate, methyl methacrylate, ethyl methacrylate, butyl methacrylate, isopropyl methacrylate, isodecyl methacrylate, cyclohexyl methacrylate, benzyl methacrylate, acrylamide, methacrylamide, vinylidine chloride, vinylidine bromide, vinyl ester, dialkyl maleate, or dialkyl fumarate; and
allowing the polymerization reaction to proceed for a second non-charging reaction time to produce a graft polymer composition having a residual vinyl aromatic monomer content of less than 350 ppm, and a residual unsaturated nitrile content of less than 50 ppm,
wherein the vinyl aromatic monomer and the unsaturated nitrile are fed to the rector over a period of 10 to 40 minutes, 25 to 35 minutes, or 30 to 35 minutes.

The above described and other features are exemplified by the following Detailed Description, and Examples.

### DETAILED DESCRIPTION

An emulsion polymerization process for the preparation of a graft polymer composition such as an ABS composition having reduced residual monomers is disclosed.

The emulsion polymerization process has a first charging stage, optionally a first non-charging reaction stage, a second charging stage, and a second non-charging reaction stage. During the first charging stage, a vinyl aromatic monomer, an unsaturated nitrile, and a first portion of an initiator are introduced, for example, continuously but separately, to a reactor containing an initial reaction system comprising water and a diene dispersion. The feeding of the vinyl aromatic monomer, the unsaturated nitrile, and the first portion of the initiator can be started at the same time.

During the second charging stage, a second portion of the initiator and a third monomer are introduced, for example, continuously but separately, to the reactor. The feeding of the second portion of the initiator and the third monomer can be started at the same time.

Between the first charging stage and the second charging stage, the emulsion polymerization reaction is also allowed to proceed during an optional first non-charging reaction stage, where no chemicals are charged to the reactor.

Following the second charging stage, the emulsion polymerization reaction is allowed to proceed to a second non-charging reaction stage to produce the graft polymer composition having reduced residual monomers. As used herein, the reaction time or process time to produce the graft polymer composition refers to the sum of the time used during the first and second charging stages, and the first and second non-charging reaction stages.

Preferably, no emulsifying agent is added to the reactor containing the initial reaction system during the first charging period, either separately or together with the vinyl aromatic monomer, or the unsaturated nitrile. No extra emulsifying agent is added to the reactor during the second charging period either. Advantageously, even without the extra emulsifying agent added, the process as described herein can still produce a graft polymer composition with a reduced residual monomer content.

In an aspect, an emulsion polymerization process of manufacturing a graft polymer composition with a reduced residual monomer content comprises feeding a vinyl aromatic monomer, an unsaturated nitrile, and a first portion of an initiator to a reactor having a temperature of 50 to 65° C., preferably 52 to 63° C., more preferably 55 to 60° C., during a first charging period. The reactor contains an initial reaction system comprising water and a diene emulsion. The temperature of the initial reaction system can be the temperature of the reactor.

After 10% to 35% or 30 to 35% or 10 to 20% of the first portion of the initiator has been added to the reactor, the reactor temperature is increased to a second temperature of 65 to 85° C., 70 to 80° C., or about 74° C., during the first charging period. For example, the reactor temperature can be increased from the first temperature to the second temperature over a period of 10 to 40 minutes or 20 to 40 minutes or over a period of 20 to 30 minutes. The second temperature can be maintained until the end of emulsion polymerization process.

The feeding of the vinyl aromatic monomer and the feeding of the unsaturated nitrile are completed within 40 minutes, within 10 to 40 minutes, within 25 to 35 minutes, or within 30 to 35 minutes, during the first charging period. All the vinyl aromatic monomer and all the unsaturated nitrile used for manufacturing the graft polymer composition can be fed to the reactor during the first charging period. The first portion of the initiator can be added at a rate of 0.5 to 1 wt % per minute. As used herein the feeding rate is a weight percent of the material such as an initiator or a monomer added to the reactor in one minute based on a total weight of the material added to the reactor during the emulsion polymerization process. The first charging period can be 60 minutes or less, or between 30 to 60 minutes.

Then the emulsion polymerization reaction is allowed to proceed for a first non-charging reaction time of 0 to 30 minutes at the second temperature after the first charging period ends and before a second charging period starts.

Thereafter, a second portion of the initiator and a third monomer are added to the reactor having the second temperature during the second charging period. The feeding of the second portion of the initiator and the third monomer can start at the same time at the beginning of the second charging period. The third monomer can be added at a rate of 15 to 25 wt % per minute, based on the total weight of the third monomer used to manufacture the graft polymer composition, and the charging of the third monomer can be completed in 4 to 7 minutes.

Then the emulsion polymerization reaction is allowed to proceed for a second non-charging reaction time to produce a graft polymer composition having a residual vinyl aromatic monomer content of less than 350 ppm, and a residual unsaturated nitrile content of less than 50 ppm. Advantageously, the graft polymer composition is produced in a process time of less than 145 minutes, preferably 110 to 145 minutes.

The first non-charging reaction time and the flow rate of the second portion of the initiator can be further optimized. With the same first charging period as described herein, when the first non-charging reaction time is 5 to 25 minutes, preferably 10 to 25 minutes, 15 to 25 minutes, or about 15 minutes, and the second portion of the initiator is added at a rate of 1.5 to 2 wt % per minute, the graft polymer composition can be produced in a process time of less than 150 minutes, preferably 110 to 150 minutes, or 120 to 150 minutes, or 130 to 145 minutes.

With the same first charging period as described herein, when the first non-charging reaction time is 0, the second portion of the initiator and the third monomer are directly added to the rector after the first charging period ends. In this instance, the second portion of the initiator is added at a rate of 0.8 to 1.2 wt % per minute, and the graft polymer composition can be produced in a process time of less than 140 minutes, preferably 105 to 135 minutes, or 110 to 130 minutes, or 115 to 125 minutes.

In an aspect, an emulsion polymerization process of manufacturing a graft polymer composition with a reduced residual monomer content comprises: feeding a vinyl aromatic monomer, an unsaturated nitrile, and a first portion of an initiator to a reactor having a temperature of 50 to 63° C., preferably 52 to 63° C., more preferably 55 to 60° C., or about 57° C., during a first charging period, the reactor containing water and a diene emulsion. In this instance, feeding the vinyl aromatic monomer and feeding the unsaturated nitrile are completed within 40 minutes, between 25 and 35 minutes, or between 30 and 35 minutes, during the first charging period. All the vinyl aromatic monomer and all the unsaturated nitrile used in the emulsion polymerization process to manufacture the graft polymer composition can be fed to the reactor during the first charging period. After 10% to 35% or 10 to 20% of the first portion of the initiator has been added to the reactor, the reactor temperature is increased to a second temperature of 65 to 85° C., 70 to 80° C., or about 74° C., during the first charging period. For example the reactor temperature can be increased from the first temperature to the second temperature over a period of 20 to 40 minutes or over 20 to 30 minutes. The second temperature can be maintained until the end of emulsion polymerization process.

The emulsion polymerization reaction in the reactor is then allowed to proceed for a first non-charging reaction time of 0 to 30 minutes, preferably 0 to 35 minutes, at the second temperature after the first charging period ends and before a second charging period starts. Then a second portion of the initiator and a third monomer are fed to the reactor having the second temperature during the second charging period. The second portion of the initiator can be added at a rate of 0.8 to 2 wt % per minute, and third monomer can be added at a rate of 15 to 25 wt % per minute. The polymerization reaction is allowed to proceed for a second non-charging time to produce a graft polymer composition having a residual vinyl aromatic monomer content of less than 350 ppm, and a residual unsaturated nitrile content of less than 50 ppm. Advantageously, the graft polymer composition is produced in a process time of less than 150 minutes, preferably 120 to 145 minutes.

As used herein, the diene emulsion in the initial reaction system refers to a diene rubber latex formed from one or more diene monomers. Examples of such diene monomers include butadiene, isoprene, chloroprene, 2-dicyclopentadiene, ethylidene norbornene, vinyl norbornene, 2-methyl-1,3-butadiene, 2,3-dimethyl-1,3-butadiene, 1,2-propadiene, 1,4-pentadiene, 1,5-hexadiene, 1,2-pentadiene, or a combination thereof. In addition to the diene monomers, up to 50 or 40 or 30 or 20 or 10 weight percent of one or more comonomers may be used based on a total weight of the monomers (i.e. the diene monomers are 50 or 60 or 70 or 80 or 90 weight percent of the monomers used). The comonomer may be another ethylenically unsaturated monomer such as styrene, ethylene, propylene, acrylonitrile, alkyl acrylates having alkyl groups of 1 to 6 carbon atoms, methyl methacrylate, or the like.

The diene emulsion is an emulsion of diene rubber latex such as polybutadiene, styrene-butadiene rubber (SBR), acrylonitrile-butadiene rubber (NBR), homopolymers of chloroprene, homopolymers of isoprene, copolymers of butadiene with isoprene, or chloroprene, poly(2-methyl-1,3-butadiene), poly(2,3-dimethyl-1,3-butadiene), poly(1,2-propadiene), poly(1,4-pentadiene), poly(1,5-hexadiene), poly(1,2-pentadiene), or ABS. Preferably the diene emulsion is an emulsion of polybutadiene.

In the diene emulsion, the diene rubber particles, for example polybutadiene particles, are dispersed in a liquid, for example water. The rubber particles may be homogenized, unhomogenized, direct growth or chemically or colloidally agglomerated. When the emulsion polymerization reaction to produce the graft polymer composition is carried out in semi-batch, batch, or continuous fashion, it is desired to utilize a homogenized diene emulsion. The average particle size of the diene rubber particles can be 50 or 100 or 150 nanometers to 500 nanometers.

An emulsifying agent may be used in the diene emulsion. Examples of such emulsifying agent include fatty acid soap or a high molecular weight alkyl or alkaryl sulfate or sulfonate or the like. The amount of emulsifying agent can be from 0.1 to 10 or 0.1 to 8 parts by weight per 100 pars by weight of the monomers used to prepare the diene emulsion.

Preferably, the diene emulsion may be a polybutadiene emulsion, dispersed in water with an emulsifying agent, such as a fatty acid soap or a high molecular weight alkyl or alkaryl sulfate or sulfonate.

The initial reaction system in the reactor may also include additional components. For example, a redox catalyst system of an Fe (II) compound with a sugar including a vanadium sugar may be used. The amount of the redox catalyst system can be from 0.01 to 2, or 0.1 to 1, or 0.5 percent by weight of the monomers used to prepare the graft polymer composition. The additional components may also include a dispersing agent such as tetrasodium pyrophosphate.

As used herein, the unsaturated nitrile is acrylonitrile, ethacrylonitrile, methacrylonitrile, α-chloroacrylonitrile, or α-bromoacrylonifrile. Combinations of two or more such monomers may be used.

Examples of vinyl aromatic monomer includes styrene, 4-methyistyrene, 3,5-diethylstyrene, 4-n-propylstyrene, α-methylstyrene, α-methyl vinyltoluene, α-chlorostyrene, α-bromostyrene, dichlorostyrene, dibromostyrene, tetrachlorostyrene, mixtures thereof, and the like. Preferably, the vinyl aromatic monomer used is styrene and/or α-methylstyrene. Combinations of two or more such monomers may be used.

The weight ratio of the vinyl aromatic monomer relative to the unsaturated nitrile can be 1.5:1 to 4:1, and preferably 2:1 to 3.5:1. The weight ratio of the diene rubber relative to the total of vinyl aromatic monomer and the unsaturated nitrile is 0.1:1 to 3:1, preferably 0.2:1 to 2:1.

During the second charging period, a third monomer is added. The third monomer is reactive with the vinyl aromatic monomer and the unsaturated nitrile. Examples of such monomers include methyl acrylate, ethyl acrylate, butyl acrylate, 2-ethylhexyl acrylate, cyclohexyl acrylate, benzyl acrylate, isopropyl acrylate, methyl methacrylate, ethyl methacrylate, butyl methacrylate, isopropyl methacrylate, isodecyl methacrylate, cyclohexyl methacrylate, benzyl methacrylate, acrylamide, methacrylamide, vinylidine chloride, vinylidine bromide, vinyl esters, dialkyl maleates or fumarates. Preferably the third monomer is methyl methacrylate. Combinations of two or more of such third monomers can be used. The amount of the third monomer can be from 2 to 5 parts by weight based on total weight of the monomers (third monomer, unsaturated nitrile monomer, and vinyl aromatic monomer) and the diene.

The polymerization is conducted in the presence of an initiator.

The initiator used in the emulsion polymerization includes peroxides and/or azo compounds which are active in grafting and decompose into radicals. Peroxy and azo initiators which have the capability to provide free radicals to the reaction may be used. Examples include cumene hydroperoxide (CHP), sodium persulfate, potassium persulfate, ammonium persulfate, di-isopropylbenzene hydroperoxide, tertbutyl-peroxide, and 2-2′azo-bis-isobutyrylnitrile (AIBN). The peroxy and azo initiators may be used in combination with other compounds such as reducing agents, heavy metal salts, complexing agents, or a redox catalyst system as described herein. Preferably, the initiator is cumene hydroperoxide, which is used in combination with a redox catalyst system, such as, Fe (II) with a sugar including a sugar with a vanadium. The redox catalyst system can be added to the initial reaction system before the monomers are charged, while the initiator can be added when the feeding of the vinyl aromatic monomer and the unsaturated nitrile begins. Thermal initiators should provide similar results if sufficient polymerization rates can be obtained.

The initiator can be used in an amount to provide sufficient initiator for the duration of the emulsion polymerization reaction. The initiator can be included within the range of 0.01 to 2 percent or within a range of 0.1 to 0.5 by weight of the polymerizable monomers (vinyl aromatic monomer, unsaturated nitrile, and the third monomer).

The graft polymer composition prepared according to the process disclosed herein can comprise less than 350 ppm, less than 300 ppm, or less than 250 ppm of the residual vinyl aromatic monomer. The graft polymer composition prepared according to the process disclosed herein can also comprise less than 50 ppm, less than 30 ppm, or less than 20 ppm of the residual unsaturated nitrile. As used herein, the level of the residual vinyl aromatic monomer and the level of the residual unsaturated nitrile are determined by gas chromatography.

The methods of the manufacture of graft polymer compositions having low residual monomers are further illustrated by the following non-limiting examples.

### EXAMPLES

### Comparative Example

Fructose or dextrose (0.36 part), tetrasodium pyrophosphate (0.036 part), and ferrous sulphate (0.006 part) were added to a reactor containing 151 parts of demineralized water and 61.5 parts of a polybutadiene rubber latex at room temperature. Then the reactor temperature was raised to 57° C. Under agitation, the feeding of styrene, the feeding of acrylonitrile, and the feeding of cumyl hydroperoxide (CHP) were started separately but at the same time (TO). The styrene (26.63 parts), acrylonitrile (8.87 parts), and CHP (0.2 part) were added to the reactor over a period of 55 minutes, 50 minutes, or 60 minutes respectively.

Twenty (20) minutes after the CHP flow started, the reactor temperature was gradually increased to 74° C. over a period of 35 minutes. Then the reactor temperature was kept at 74° C. until the end of the reaction.

After the CHP flow stopped, the reaction mixture was stirred at 74° C. for 45 minutes. Then the feeding of a second dose of CHP (0.25 part) and the feeding of methacrylate (MMA) were started at the same time. MMA (3 parts) was added in 5 minutes, and the second dose of CHP was added over a period of 30 minutes.

After 165 minutes since the first CHP dosing started (TO), the reaction was stopped by dropping the contents in the reactor to a holding vessel.

### Example 1

The process of the comparative example was repeated with the following differences. In example 1, styrene was added to the reactor over a period of 35 minutes instead of 55 minutes, and the acrylonitrile was added over a period of 30 minutes instead of 50 minutes. In addition, the temperature increase (from 57 to 74° C.) started 10 minutes after the first CHP dosing started, and the ramping was finished in 25 minutes. In addition, the second CHP dosing started 25 minutes after the first CHP dosing finished. After 145 minutes since the first CHP dosing started (TO), the reaction was stopped by dropping the contents in the reactor to a holding vessel.

### Example 2

The process of example 1 was repeated with the following differences. In example 2, the second CHP dosing started 15 minutes after the first CHP dosing finished. After 135 minutes since the first CHP dosing started (TO), the reaction was stopped by dropping the contents in the reactor to a holding vessel.

### Example 3

The process of example 1 was repeated with the following differences. In example 3, the second CHP dosing started right after the first CHP dosing finished and last for 50 minutes rather than 30 minutes as in the comparative example. After 120 minutes since the first CHP dosing started (TO), the reaction was stopped by dropping the contents in the reactor to a holding vessel.

The starting and ending time in minutes measured from TO for each step are summarized in Table 1.

TABLE 1

| | Comparative | | | |
|---|---|---|---|---|
| Process | Example | Example 1 | Example 2 | Example 3 |
| Add Acrylonitrile | 0-50 | 0-30 | 0-30 | 0-30 |
| Add Styrene | 0-55 | 0-35 | 0-35 | 0-35 |
| Add 1^{st} CHP | 0-60 | 0-60 | 0-60 | 0-60 |
| Heat to 74° C. | 20-55 | 10-35 | 10-35 | 10-35 |
| Keep temperature | 55-165 | 35-145 | 35-135 | 35-120 |
| @ 74° C. | | | | |
| Add 2^{nd} CHP | 110-135 | 85-115 | 75-105 | 60-110 |
| Add MMA | 105-110 | 85-90 | 75-80 | 60-65 |

### Residual Styrene and Residual Acrylonitrile

The residual styrene and residual acrylonitrile levels in the reaction products of Examples 1-3 and the comparative example were analyzed by gas chromatography, and the results are summarized in Table 2.

TABLE 2

| | Total Reaction | Residual | Residual |
|---|---|---|---|
| Entry | Time (min) | Styrene (ppm) | Acrylonitrile (ppm) |
| Comparative | 165 | 581 | 64 |
| Example | | | |
| Example 1 | 145 | 218 | 19 |
| Example 2 | 135 | 222 | 14 |
| Example 3 | 120 | 185 | 16 |

The data in the table shows that graft polymer compositions prepared by the process of the disclosure have reduced residual styrene and reduced residual acrylonitrile levels. It is unexpected that graft polymer compositions with reduced residual monomer levels can be manufactured by shorting, rather than extending the reaction time.

The singular forms “a,” “an,” and “the” include plural referents unless the context clearly dictates otherwise. The endpoints of all ranges directed to the same component or property are inclusive and independently combinable. Unless defined otherwise, technical and scientific terms used herein have the same meaning as is commonly understood by one of skill in the art to which this invention belongs. As used herein, a “combination” is inclusive of blends, mixtures, alloys, reaction products, and the like.

All references cited herein are incorporated by reference in their entirety. While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

1. An emulsion polymerization process of manufacturing a graft polymer composition with a reduced residual monomer content, the process comprising:
feeding a vinyl aromatic monomer, an unsaturated nitrile, and a first portion of an initiator to a reactor having a temperature of 50 to 63° C. during a first charging period, the reactor containing an initial reaction system comprising water and a diene emulsion;
after 10% to 35% of the first portion of the initiator has been added to the reactor, increasing the reactor temperature to a second temperature of 65 to 85° C. during the first charging period;
allowing a polymerization reaction in the reactor to proceed for a first non-charging reaction time of 0 to 30 minutes at the second temperature after the first charging period ends and before a second charging period starts;
feeding a second portion of the initiator and a third monomer to the reactor having the second temperature during the second charging period, wherein the third monomer is at least one of a methyl acrylate, ethyl acrylate, butyl acrylate, 2-ethylhexyl acrylate, cyclohexyl acrylate, benzyl acrylate, isopropyl acrylate, methyl methacrylate, ethyl methacrylate, butyl methacrylate, isopropyl methacrylate, isodecyl methacrylate, cyclohexyl methacrylate, benzyl methacrylate, acrylamide, methacrylamide, vinylidine chloride, vinylidine bromide, vinyl ester, dialkyl maleate, or dialkyl fumarate; and
allowing the polymerization reaction to proceed for a second non-charging reaction time to produce a graft polymer composition having a residual vinyl aromatic monomer content of less than 350 ppm, and a residual unsaturated nitrile content of less than 50 ppm,
wherein the vinyl aromatic monomer and the unsaturated nitrile are fed to the reactor over a period of 10 to 40 minutes.

2. The emulsion polymerization process of claim 1, wherein no emulsifying agent is added to the reactor containing the initial reaction system during the first charging period.

3. The emulsion polymerization process of claim 1, wherein the first non-charging reaction time is 5 to 25 minutes.

4. The emulsion polymerization process of claim 3, wherein the second portion of the initiator is fed to the reactor at a rate of 1.5 to 2 wt % per minute, and the rate is a weight percent of the initiator added to the reactor per minute based on a total weight of the initiator added to the reactor during the emulsion polymerization process.

5. The emulsion polymerization process of claim 4, wherein the graft polymer composition is produced at a process time of less than 150 minutes, and the process time is a sum of the first charging period, the first non-charging reaction time, the second charging period, and the second non-charging reaction time.

6. The emulsion polymerization process of claim 1, wherein the first non-charging reaction time is 0.

7. The emulsion polymerization process of claim 6, wherein the second portion of the initiator is fed to the reactor at a rate of 0.8 to 1.2 wt % per minute, and the rate is a weight percent of the initiator added to the reactor per minute based on a total weight of the initiator added to the reactor during the emulsion polymerization process.

8. The emulsion polymerization process of claim 7, wherein the graft polymer composition is produced in less than 140 minutes, and the process time is a sum of the first charging period, the first non-charging reaction time, the second charging period, and the second non-charging reaction time.

9. The emulsion polymerization process of claim 1, wherein all the vinyl aromatic monomer and all the unsaturated nitrile used for manufacturing the graft polymer composition are fed to the reactor during the first charging period.

10. The emulsion polymerization process of claim 1, wherein the first portion of the initiator is added at a rate of 0.5 to 1 wt % per minute, and the rate is a weight percent of the initiator added to the reactor per minute based on a total weight of the initiator added to the reactor during the emulsion polymerization.

11. The emulsion polymerization process of claim 1, the process comprising:
feeding the vinyl aromatic monomer, the unsaturated nitrile, and the first portion of the initiator to the reactor having the temperature of 50 to 63° C. during the first charging period, the reactor containing water and a diene emulsion;
after 10% to 35% of the first portion of the initiator has been added to the reactor, increasing the reactor temperature to the second temperature of 65 to 85° C. during the first charging period;
allowing the polymerization reaction in the reactor to proceed for the first non-charging reaction time of 0 to 30 minutes at the second temperature after the first charging period ends and before a second charging period starts;
feeding the second portion of the initiator and a third monomer to the reactor having the second temperature during the second charging period; and
allowing the polymerization reaction to proceed for the second non-charging reaction time to produce the graft polymer composition having the residual vinyl aromatic monomer content of less than 350 ppm, and the residual unsaturated nitrile content of less than 50 ppm,
wherein feeding the aromatic vinyl monomer and feeding the unsaturated nitrile are completed within 40 minutes during the first charging period.

12. The emulsion polymerization process of claim 11, wherein the graft polymer composition is produced at a process time of less than 150 minutes, and the process time is a sum of the first charging period, the first non-charging reaction time, the second charging period, and the second non-charging reaction time.

13. The emulsion polymerization process of claim 1, wherein the first portion of the initiator and the second portion of the initiator have a weight ratio of 1:2 to 2:1.

14. The emulsion polymerization process of claim 1, wherein
the diene emulsion is a polybutadiene emulsion;
the vinyl aromatic monomer is at least one of styrene or α-methylstyrene;
the unsaturated nitrile is at least one of acrylonitrile, ethacrylonitrile, methacrylonitrile, α-chloroacrylonitrile, or α-bromoacrylonifrile; and
the initiator is at least one of cumene hydroperoxide, sodium persulfate, potassium persulfate, ammonium persulfate, di-isopropylbenzene hydroperoxide, or tertbutyl-peroxide.

15. The emulsion polymerization process of claim 1, wherein the initial reaction system further comprises a redox catalyst system comprising an Fe (II) compound and a sugar.

16. An emulsion polymerization process of manufacturing a graft polymer composition with a reduced residual monomer content, the process comprising:
feeding a vinyl aromatic monomer, an unsaturated nitrile, and a first portion of an initiator to a reactor having a temperature of 55 to 60° C., during a first charging period, the reactor containing an initial reaction system comprising water and a diene emulsion;
after 100 to 20% of the first portion of the initiator has been added to the reactor, increasing the reactor temperature to a second temperature of 70 to 80° C. during the first charging period;
allowing a polymerization reaction in the reactor to proceed for a first non-charging reaction time of 0 to 30 minutes at the second temperature after the first charging period ends and before a second charging period starts;
feeding a second portion of the initiator and a third monomer to the reactor having the second temperature during the second charging period, wherein the third monomer is at least one of a methyl acrylate, ethyl acrylate, butyl acrylate, 2-ethylhexyl acrylate, cyclohexyl acrylate, benzyl acrylate, isopropyl acrylate, methyl methacrylate, ethyl methacrylate, butyl methacrylate, isopropyl methacrylate, isodecyl methacrylate, cyclohexyl methacrylate, benzyl methacrylate, acrylamide, methacrylamide, vinylidine chloride, vinylidine bromide, vinyl ester, dialkyl maleate, or dialkyl fumarate; and
allowing the polymerization reaction to proceed for a second non-charging reaction time to produce a graft polymer composition having a residual vinyl aromatic monomer content of less than 350 ppm, and a residual unsaturated nitrile content of less than 50 ppm,
wherein the vinyl aromatic monomer and the unsaturated nitrile are fed to the reactor over a period of 30 to 35 minutes.

17. The graft polymer composition of claim 16, wherein the initiator is cumene hydroperoxide.

18. The graft polymer composition of claim 17, wherein the third monomer is methyl methacrylate.

19. A graft polymer composition, wherein:
the graft polymer composition is formed from a vinyl aromatic monomer, an unsaturated nitrile, and a third monomer;
a residual vinyl aromatic monomer content of the graft polymer composition is less than 350 ppm, and
a residual unsaturated nitrile content of the graft polymer composition is less than 50 ppm.

20. The graft polymer composition of claim 19, wherein:
the residual vinyl aromatic monomer content is less than 250 ppm, and
the residual unsaturated nitrile content is less than 20 ppm.
